(19) United States
(12) Patent Application Publication
(10) Pub. No.: US 2025/0222905 A1
(43) Pub. Date: Jul. 10, 2025

(54) Carrying apparatus for carrying motor vehicles

(71) Applicant: HERRMANN AG, Poesing (DE)

(72) Inventor: David HERRMANN, Regensburg (DE)

(21) Appl. No.: 19/011,254

(22) Filed: Jan. 6, 2025

(30) Foreign Application Priority Data
Jan. 5, 2024 (DE) 10 2024 100 268.9

(51) Int. Cl. B60S 13/02; B66F 7/28

(52) U.S. Cl. CPC B60S 13/02; B66F 7/28

(57) ABSTRACT

A carrying apparatus for lifting and/or carrying motor vehicles has a first connecting device configured to be connected to a support arm of a lifting platform and/or can be received by the support arm, and having a receiving device arranged on the connecting device and having a carrying device received by the receiving device for carrying the motor vehicle. The connecting device forms a support section for supporting the carrying device. The carrying device is movable along a straight direction relative to the receiving device and a suspension device is provided which urges the carrying device into a first position of the carrying device relative to the receiving direction.

### BACKGROUND OF THE INVENTION

The present invention relates to lifting devices for lifting vehicles, such as lifting platforms. Such lifting platforms have been known for a long time. Typically, such lifting platforms have several, for example four support arms to which support elements are attached, which are pushed under the motor vehicle to be lifted. The vehicle can be lifted by raising these support arms.

In the case of conventional vehicles with combustion engines, it is relatively uncritical to arrange the carrying device or the support element underneath the vehicle because the carrying parts of the vehicle occupy a considerable surface area there. Lifting electrically powered vehicles is much more critical. One of the reasons for this is the vehicle's battery, which is very sensitive and can be destroyed by the lifting process.

With electrically powered vehicles, however, it is necessary to position the support arms or the individual support elements very precisely at predetermined positions on the vehicle in order to be able to lift the vehicle in this way.

The present invention is therefore based on the object of simplifying a lifting process for a wide variety of vehicles and in particular also for electrically powered vehicles.

### SUMMARY OF THE INVENTION

A carrying apparatus according to the invention for lifting and/or carrying motor vehicles, in particular by means of lifting platforms, has a first connecting means which can be connected to a support arm of a lifting platform and/or can be received by the support arm and a receiving device arranged on the connecting means (in particular rigidly) and a carrying device received by the receiving device for carrying the motor vehicle, wherein the receiving device forms a support section for supporting the carrying device.

According to the invention, the carrying device is arranged to be movable along a straight and in particular vertical direction relative to the receiving device and a suspension means is provided which urges the carrying device into a first position of the carrying device relative to the receiving device.

In contrast to corresponding carrying devices known from the prior art, it is proposed here that the carrying device itself is movable relative to the receiving device and is therefore also movable relative to the support arm within a predetermined range. In this way, the positioning of the support arm and the carrying device can be considerably simplified.

A further carrying apparatus according to the invention for lifting and/or carrying motor vehicles, in particular by lifting platforms, has a first connecting means which can be connected to a support arm of a lifting platform and/or which can be received by the support arm, wherein a receiving device is arranged on the connecting means (and/or the connecting means forms and/or has a receiving device).

In a preferred embodiment, the carrying device can be moved relative to the support section in a direction perpendicular to the straight direction.

In a further advantageous embodiment, the carrying device can be rotated relative to the support section in a vertical direction.

This enables easier positioning in relation to the vehicle to be lifted.

In a further preferred embodiment, the carrying device is placed loosely on the support section.

In a further preferred embodiment, the support section forms a support surface within which the carrying device is movable relative to the support section and, in particular, freely movable.

In a further preferred embodiment, the support section forms a circumferential edge which limits the movement of the carrying device relative to a support surface within which the carrying device is movable relative to the support section. In this way, the carrying device can preferably be moved and/or rotated essentially freely within a surface formed by this circumferential edge. This in turn facilitates positioning under a vehicle to be lifted.

Particularly preferably, the circumferential edge is circular.

In a further preferred embodiment, a recess and in particular a recess extending in the straight direction is arranged in the receiving device and the suspension means is arranged within this recess.

Preferably, the suspension means is movably arranged within this recess.

In contrast to the other embodiments, the suspension means here is therefore a component of the receiving device, i.e. in particular the device that is brought into connection with the vehicle.

In a further preferred embodiment, the recess has a constant cross-section (in particular in the straight direction).

In a further preferred embodiment, the recess forms a chamber and in particular a closed chamber in which the suspension means is arranged.

In this way, it can be ensured that the suspension means cannot fall out of the recess and/or the receiving device. In a further preferred embodiment, the suspension means is attached to at least one wall that defines the recess.

In a further preferred embodiment, the recess (in the connecting means) has a length in the straight direction that is greater than 2 cm, preferably greater than 3 cm, preferably greater than 4 cm.

In a further preferred embodiment, the recess has a length in the straight direction that is less than 20 cm, preferably less than 15 cm, preferably less than 10 cm and particularly preferably less than 8 cm.

In a further preferred embodiment, the recess has a diameter in a direction perpendicular to the straight direction that is greater than 1 cm, preferably greater than 1.5 cm, preferably greater than 2 cm, preferably greater than 2.5 cm.

In a further preferred embodiment, the recess has a diameter in a direction perpendicular to the straight direction that is smaller than 10 cm, preferably smaller than 8 cm, preferably smaller than 6 cm.

Preferably, the receiving device is a component of the connecting means. In this embodiment, the connecting means preferably has a support element and, in particular, a circumferential support collar with which the connecting means can be supported relative to the support arm. Preferably, the connecting means is formed in one piece and/or the receiving device and the support element are formed in one piece with each other.

The connecting means preferably has a main body, in particular in the form of a sleeve, which can be inserted into the support arm. Preferably, this sleeve-shaped main body can be arranged in a hole in the support arm with essentially no play. Preferably, the sleeve-shaped main body is longer than a thickness of the support arm, so that the sleeve-shaped main body protrudes downwards beyond the support arm, in particular when inserted into the support arm.

In addition, a carrying device received by the receiving device is provided for carrying the motor vehicle, wherein the connecting means forms a support section for supporting the carrying device. Preferably, this is a circumferential support section.

According to the invention, the carrying device is movable along a straight direction relative to the receiving device and a suspension means is provided which urges the carrying device into a first position of the carrying device relative to the receiving direction.

The difference between the two embodiments of the carrying device described here is that in the first embodiment, an extension arm is provided (or the receiving device has an extension arm), which is arranged on the support arm. This extension arm provides increased freedom of movement for certain support arms. In the second embodiment, such an extension arm is not provided, but a connecting means is arranged directly in the support arm.

Preferably, the first position is a position in which a contact body arranged on the carrying device, which carries the vehicle to be lifted, is at a maximum distance from the support arm and/or the connecting means (in particular in a vertical direction).

In a further preferred embodiment, the suspension device is arranged at least partially and preferably completely above the support arm and/or below the support arm. In this way, the accessibility of the suspension device can be improved.

This support arm can be dispensed with, in particular in the case of smaller support arms. However, both carrying devices have the same idea in common, namely that the suspension device allows a certain freedom of movement of the carrying device, which enables the carrying device to be arranged on different vehicles.

It is therefore possible for the support arm to first be brought into a predetermined position, subsequently a user can load the carrying device or press it down in order to guide it with the support arm into the exact target position of the vehicle. The user can then release the carrying device so that it rests against the desired part of the vehicle underbody.

Particularly preferably, the spring-loaded carrying device serves as a positioning aid for correctly positioning the support arm and/or the carrying apparatus in relation to a motor vehicle to be lifted. Preferably, the suspension means serves as a positioning aid, in particular for manually positioning the carrying device relative to the vehicle.

In a preferred embodiment, the connecting means with which the carrying device is arranged on the support arm is a bolt or a cylindrical body which can be guided in particular into an opening in the support arm provided for receiving it.

The carrying apparatus is particularly preferably used for lifting motor vehicles and in particular for lifting electrically powered motor vehicles, in particular purely electrically powered motor vehicles or hybrid vehicles. In particular, the motor vehicles are passenger cars.

In a preferred embodiment, the carrying apparatus can have a sensor device for measuring a weight force (e.g. of a vehicle). In this way, an individual load or weight force acting on a corresponding support arm can be determined.

Preferably, this sensor device is arranged in the connecting device, in the receiving device and/or in the carrying device. Preferably, this sensor device has a transmitting device in order to output at least one signal for a weight force (for example of a vehicle to be lifted) and in particular to output it wirelessly.

In a further preferred embodiment, the carrier apparatus has an energy storage device, such as a battery, to supply the said sensor device and/or the transmitter device with electrical energy.

In a preferred embodiment, the sensor device is arranged between the receiving device and the support arm.

In a further preferred embodiment, the sensor device is arranged on or between the receiving device and the carrying device.

For example, the sensor device can have a strain gauge.

In a further advantageous embodiment, the first connecting means has a cylindrical projection that engages in an opening in the support arm. It is possible for the connecting means to be rotatable relative to the opening of the support arm. In particular, it is possible that the carrying device or the carrying apparatus can be positioned at a plurality of different angles in relation to the support arm. However, it is also possible that only a few different angular positions of the carrying device relative to the support arm are possible.

In a further preferred embodiment, the receiving device is a recess arranged in the connecting means, which preferably extends in the aforementioned (in particular vertical) direction. This embodiment relates in particular to the second embodiment described above, which dispenses with an extension arm.

In particular, the recess is a bore and, in particular, a through bore in which the carrying device can slide. Preferably, this recess has a circular cross-section and/or a constant cross-section.

In a further advantageous embodiment (which relates to the first of the embodiments described above), the receiving device is offset relative to the connecting means in a plane which is perpendicular to a lifting direction, wherein preferably a distance between the receiving device and the connecting means is greater than 20 mm, preferably greater than 40 mm, preferably greater than 50 mm, and preferably greater than 55 mm.

In a further preferred embodiment, a distance between the receiving device and the connecting means is less than 200 mm, preferably less than 150 mm, preferably less than 120 mm. Preferably, the distance in an assembled state of the carrying device is a distance in a horizontal plane.

Preferably, the said distance refers to the centre axis of the connecting means and the holding device.

These distances have proven to be particularly advantageous in order to enable easy positioning of the carrying device in relation to the motor vehicle on the one hand and to keep the lifting arm of a corresponding extension arm within reasonable limits on the other hand.

In a further preferred embodiment, the carrying apparatus has an extension arm on which the connecting means and also the receiving device are arranged.

Preferably, this extension arm is web-like or plate-like.

Particularly preferably, the extension arm has a first area with a first thickness and a second area with a second thickness. The thickness in each of these areas is particularly preferably constant. Particularly preferably, the connecting means is arranged in the area with the first thickness, which is preferably a smaller thickness. Particularly preferably, the thickness is greater in the area with the second thickness, in which the receiving device is arranged.

The first thickness is preferably between 5 mm and 20 mm, preferably between 7 mm and 15 mm and particularly preferably between 8 mm and 12 mm.

The second thickness is preferably between 7 mm and 30 mm, preferably between 8 mm and 25 mm, preferably between 10 mm and 20 mm.

Preferably, the area with the lower thickness, in which the connecting means is preferably also located, is supported by the support arm in a mounted state (of the carrying apparatus on the support arm). Preferably, in a mounted state of the carrying apparatus on a support arm, the area with the greater thickness, in which the receiving device is preferably located, protrudes beyond the support arm.

In a further advantageous embodiment, the carrying device is movable along a straight direction and in particular the above-mentioned straight direction relative to the receiving device or the connecting means (in particular in the second embodiment according to the invention) between two end positions.

Particularly preferably, these end positions are at a distance from one another and/or the maximum movement path of the carrying device relative to the receiving device is greater than 10 mm, preferably greater than 15 mm and particularly preferably greater than 20 mm.

Preferably, the said maximum movement path of the carrying device relative to the receiving device is less than 200 mm, preferably less than 150 mm, preferably less than 100 mm, preferably less than 70 mm and particularly preferably less than 50 mm.

Particularly preferably, at least one of the end positions and preferably both end positions are defined by stops. In this way, the movement path is defined which a user of the carrying device can move it, in particular by manually pressing it, and thus place the carrying device in the desired position. This movement path is particularly preferably selected in such a way that the carrying device can be moved into any position relative to the vehicle to be lifted by pushing it.

Particularly preferably, the lower end position of the carrying device relative to the receiving device is defined by the above-mentioned support section of the carrying apparatus. Particularly preferably, the upper end position is defined by a circumferential collar arranged on the rod-like body.

In a further advantageous embodiment, the carrying device has a rod-like body, which is preferably guided in the receiving device and/or the connecting means (in particular in the second embodiment described) and preferably a contact body for contacting the motor vehicle. Preferably, the receiving device has guide means for guiding the rod-like body. Preferably, an opening is formed in the above-mentioned extension arm through which the rod-like body extends. Preferably, a length of this guide means is given by a thickness of the extension arm in the area of the receiving device. In particular, this is the second thickness mentioned above.

In this design, the carrying device is made in at least two parts. It is possible that a fastening collar is arranged and, in particular, welded to the rod-like body. The contact body mentioned above is again preferably arranged on this fastening collar.

Particularly preferably, the contact body is detachably attached to the rod-like body. In this way, the contact body can be designed in the form of an adapter so that different contact bodies are or can be attached to the rod-like body depending on the type of vehicle to be lifted.

In a further preferred embodiment, the carrying apparatus has an adapter device which makes it possible to arrange different contact bodies on the carrying device and in particular on the rod-like body. In this way, the carrying apparatus can be adapted to different vehicle types and in particular to the bottoms of different motor vehicles.

However, it would also be possible for the above-mentioned support surface, on which the carrying device can be arranged, to represent the adapter device.

In a further preferred embodiment, the adapter device has a first adapter element on which different contact bodies can be arranged, wherein these contact bodies can preferably be arranged on the adapter element by plugging them on.

This first adapter element is preferably arranged on the rod-like body and preferably attached to it, for example by screws or permanently attached.

This first adapter element preferably has a first adapter section on which different contact bodies (for different vehicles) can be arranged.

Preferably, this contact body can be plugged onto the adapter element. Preferably, the contact body has a second adapter section that interacts with the first adapter section. Preferably, the second adapter section and the first adapter section lie flat against each other.

Preferably, the adapter element and/or the first adapter section have a circular cross-section. Particularly preferably, the second adapter section also has a circular cross-section. In this way, the contact body can be plugged onto the adapter element regardless of its rotational position.

Particularly preferably, the adapter element has a centring projection that is suitable and intended to engage in a centring receptacle of the contact body.

This centring projection can be designed as a centring bolt or centring pin.

Conversely, it would also be possible for a centring projection to be arranged on the contact body and a corresponding centring receptacle on the adapter element.

This centring projection is particularly preferably arranged centrally in relation to the adapter element (or the contact body).

The centring projection is particularly preferably designed to be rotationally symmetrical.

In a further preferred embodiment, the centring projection has a cylindrical section. In a further preferred embodiment, the centring projection has a conical or frustoconical section. Preferably, this conical (frustoconical) section is an end section of the centring projection.

A flexible element is particularly preferably arranged on this centring projection and, in particular, a flexible element running around the centring projection. The flexible element is preferably an O-ring.

As mentioned above, a fastening collar is particularly preferably arranged on the rod-like body. This fastening collar is particularly preferably welded to the rod-like body and particularly preferably welded all round.

This fastening collar preferably forms, on the one hand, the fastening means for fastening the contact body. Preferably, however, this fastening collar also forms the support surfaces or those surfaces which come into contact with the support surfaces of the receiving device when the carrying device is pressed down.

Particularly preferably, the contact body is screwed to the rod-like body (and in particular the fastening collar). This allows the contact body to be changed quickly. However, it would also be possible for the contact body to be connected to the rod-like body with a bayonet-type connection.

It would also be possible for the contact body to be held on the rod-like body by a magnetic force. This would make it easy to replace.

In a further advantageous embodiment, the rod-like body has a receiving space for receiving the suspension device. When the contact body is pressed down, the suspension device can be received in this receiving space.

Preferably, therefore, the rod-like body (in relation to its longitudinal direction) is designed in sections as a hollow cylinder and in sections as a solid cylinder. Particularly preferably, the section of the rod-like body designed as a solid cylinder faces the contact body and the section designed as a hollow cylinder is arranged opposite the contact body or at the opposite distal end of the rod-like body.

Preferably, that part of the rod-like body which is formed as a hollow cylinder extends to between 10% and 60% of the total length of the rod-like body, preferably to between 15% and 50%, preferably to between 20% and 40%.

In a further advantageous embodiment, the rod-like body is made of a metal and in particular of steel. In a further advantageous embodiment, the contact body is made of a plastic, which is selected in particular from a group of plastics comprising POM, PET, PVC and the like.

In a further advantageous embodiment, engagement means are formed on the contact body for engaging in areas of a motor vehicle. These engagement means can, for example, be a linear groove which is suitable and intended to receive an end edge of the motor vehicle. In this way, it is possible to ensure that the contact body is positioned precisely at the desired position on the motor vehicle.

Preferably, the motor vehicle is an at least partially electrically powered motor vehicle, in particular a purely electrically powered motor vehicle or a hybrid powered motor vehicle. The application described here is particularly favourable for such motor vehicles, since the batteries of these motor vehicles are relatively sensitive and are arranged underneath or on the bottom of the motor vehicle.

In a further preferred embodiment, a second support section is arranged on the rod-like body, which has a support surface which, in a position of the rod-like body, co-operates with the support section of the receiving device and/or the extension arm.

Preferably, this support section (of the receiving device and/or the extension arm) is circular in shape. The second support section mentioned is also preferably circular. In a lifting state of the vehicle, the two support sections preferably lie flat against each other.

In a further advantageous embodiment, the receiving device has a receiving space for receiving the suspension element or the suspension means.

Preferably, the suspension means is a coil spring. This can preferably be attached and/or arranged completely within the receiving space.

Preferably, the receiving space has a bottom against which the suspension means is supported. This bottom is preferably non-carrying (with regard to the vehicle to be lifted).

In a further advantageous embodiment, the receiving space has a circumferential wall that surrounds the suspension means. This wall can, for example, be made of a non-carrying material such as sheet metal.

In a further preferred embodiment, said receiving space (or the walls forming this receiving space) is bolted or fastened to the extension arm.

In a further advantageous embodiment, the suspension means is selected from a group of suspension means comprising coil springs, pneumatic spring means, hydraulic suspension means and magnetic suspension means and the like In addition, the suspension means may also comprise other elastic bodies such as foams.

In a further advantageous embodiment, the suspension device or the suspension means has a spring strength that is greater than 10 N, preferably greater than 20 N, preferably greater than 30 N and particularly preferably greater than 40 N.

In a further preferred embodiment, the suspension device has a spring strength that is less than 400 N. Preferably less than 300 N, preferably less than 200 N, preferably less than 100 N and particularly preferably less than 80 N and particularly preferably less than 60 N.

The spring strength is particularly preferably selected so that a user can comfortably push the contact body onto the receiving device by hand in order to position the carrying apparatus.

In a further advantageous embodiment, the carrying device is rotatably mounted relative to the receiving device and/or the connecting means (in particular in the second embodiment). In this way, it is easier to adapt to different conditions of the vehicle. Particularly preferably, the carrying device is rotatable about 360° relative to the receiving device.

Preferably, the receiving device has a circular opening and the rod-like body has a cylindrical cross-section. This allows easy adjustment (of a rotational position) of the contact body.

In a further advantageous embodiment, the carrying apparatus has a releasable securing means that prevents unintentional removal of the carrying apparatus from the support arm. These securing means do not have to be able to withstand high forces; it is sufficient to prevent unintentional removal of the carrying device from the support arm.

For this purpose, a through-opening can be provided in a cylindrical projection of the connecting means.

Preferably, the carrying apparatus has a guide body for guiding the carrying device. Preferably, the carrying device is linearly movable relative to this guide body in its direction of movement. This guide body is particularly preferably made of metal or plastic.

This guide body is particularly preferably arranged in a radial direction between the carrying apparatus and the connecting means. This guide body can be designed as a sliding sleeve.

Preferably, this guide body is sleeve-like and/or has a sleeve-like section. Particularly preferably, this guide body has a support means which is suitable and intended to be supported relative to the connecting means. Preferably, this support means is an in particular a circumferential support collar. Preferably, the support means projects outwards in a radial direction with respect to the guide body and extends in particular perpendicular to a sleeve-shaped section of the guide body.

Preferably, the guide body can be inserted into the connecting means.

The guide body preferably has at least one, preferably at least two guide grooves. These guide grooves are preferably formed in a sleeve-shaped section of the guide body. Preferably, at least four and particularly preferably exactly four such guide grooves are provided. Particularly preferably, two first of these guide grooves have a different length than two further of these guide grooves.

Preferably, these guide grooves are straight. Preferably, these guide grooves extend in a longitudinal direction of the carrying apparatus and/or a direction of movement of the contact body relative to the connecting means.

In a further preferred embodiment, at least two guide pins are provided on the carrying device, which preferably project from the carrying device in a radial direction. Preferably, exactly two such guide pins are provided.

Preferably, these guide pins can be guided in guide grooves and in particular in guide grooves of said guide body

In a further preferred embodiment, the apparatus has an adaptation body to adapt the device to different support arms. The support arms of the lifting platforms from different manufacturers sometimes have different openings into which the carrying apparatuses can be inserted. These diameters can vary considerably, for example between 30 mm and 70 mm.

The adaptation body allows the carrying apparatuses to be adapted to these different openings.

This adaptation body is particularly preferably designed as a sleeve body. The connecting means can preferably be inserted into this sleeve body and the connecting means can preferably be connected to this sleeve body. Preferably, the carrying apparatus can be inserted into the support arm together with this sleeve body.

This sleeve body therefore allows adapting to different support arms.

Preferably, the sleeve body has a circular inner cross-section and a circular outer cross-section. However, it would also be conceivable for the outer cross-section to have a cross-section that deviates from a circular cross-section. In this way, the sleeve body could also be inserted in support arms whose openings have a non-circular cross-section.

The present invention is further directed to a lifting platform for lifting motor vehicles, having several support arms which are suitable and intended for lifting the vehicle, wherein a carrying apparatus of the type described above is arranged on at least one support arm. Particularly preferably, such a carrying apparatus is arranged on several support arms and particularly preferably on each support arm.

In a further advantageous embodiment, the lifting platform has a detection device for detecting the force measured by the at least one sensor device. Preferably, the detection device is suitable and intended for detecting the forces (which are exerted in particular by a motor vehicle to be lifted) measured by several sensor devices.

Further advantages and embodiments are shown in the attached drawings:

### BRIEF DESCRIPTION OF THE DRAWINGS

In the figures:

FIG. 1 shows an illustration of a carrying apparatus according to the invention;

FIG. 2 shows the carrying apparatus from FIG. 1, arranged on a support arm;

FIG. 3 shows a sectional view of the carrying apparatus shown in FIG. 1;

FIG. 4 shows a sectional view of the carrying apparatus shown in FIG. 2;

FIG. 5a shows a view from above of a carrying apparatus according to the invention;

FIG. 5b shows a sectional view along line A-A from FIG. 5a;

FIG. 6a shows a further top view of a carrying apparatus according to the invention;

FIG. 6b shows a sectional view along line B-B from FIG. 6a;

FIG. 7a shows a top view of a carrying apparatus arranged on a support arm;

FIG. 7b shows a sectional view along line C-C in FIG. 7a;

FIG. 8 shows an exploded view of a carrying apparatus according to the invention;

FIGS. 9a-c show representations of an adapter device in a first embodiment;

FIGS. 10a-c show representations of an adapter device in a second embodiment;

FIGS. 11a-c show illustrations of an adapter device in a third embodiment;

FIG. 12 shows an illustration of apparatuses according to the invention arranged on support arms;

FIG. 13 shows a further embodiment of a carrying apparatus according to the invention;

FIG. 14 shows a further embodiment of a carrying apparatus according to the invention;

FIG. 15 shows a further embodiment of a carrying apparatus according to the invention;

FIG. 16 shows a further embodiment of a carrying apparatus in a relaxed state;

FIG. 17 shows the embodiment in FIG. 16 in a tensioned state;

FIG. 18 shows a sectional view of the carrying apparatus shown in FIG. 16;

FIG. 19 shows a sectional view of the carrying apparatus shown in FIG. 17;

FIG. 20 shows a perspective view of the carrying apparatus shown in FIG. 16;

FIG. 21 shows a perspective view of the carrying apparatus shown in FIG. 17;

FIG. 22 shows an illustration of a further carrying apparatus in a relaxed state;

FIG. 23 shows the carrying apparatus from FIG. 22 in a tensioned state;

FIG. 24 shows an exploded view of the carrying apparatus shown in FIG. 22;

FIGS. 25a, b show a further embodiment of a carrying apparatus according to the invention;

FIGS. 26a, b show two sectional views of the carrying apparatuses shown in FIG. 25a,b;

FIG. 26c shows an exploded view of the carrying apparatus of FIG. 25a,b; and

FIG. 27 shows a further carrying apparatus according to the invention;

FIGS. 28a, b show two illustrations of a further apparatus according to the invention;

FIGS. 29a, b show two illustrations of a further apparatus according to the invention;

FIGS. 30a, b show two illustrations of an apparatus according to the invention with magnetic suspension means;

FIGS. 31a, b. show two illustrations of an apparatus according to the invention with magnetic suspension means;

FIGS. 32a, b show two illustrations of an apparatus according to the invention with suspension means integrated into the connecting means;

FIGS. 33a-d show four representations of an apparatus according to the invention with suspension means integrated in the connecting means; and

FIGS. 34a-d show four illustrations of an apparatus according to the invention with suspension means integrated into the connecting means.

### DETAILED DESCRIPTION OF THE INVENTION

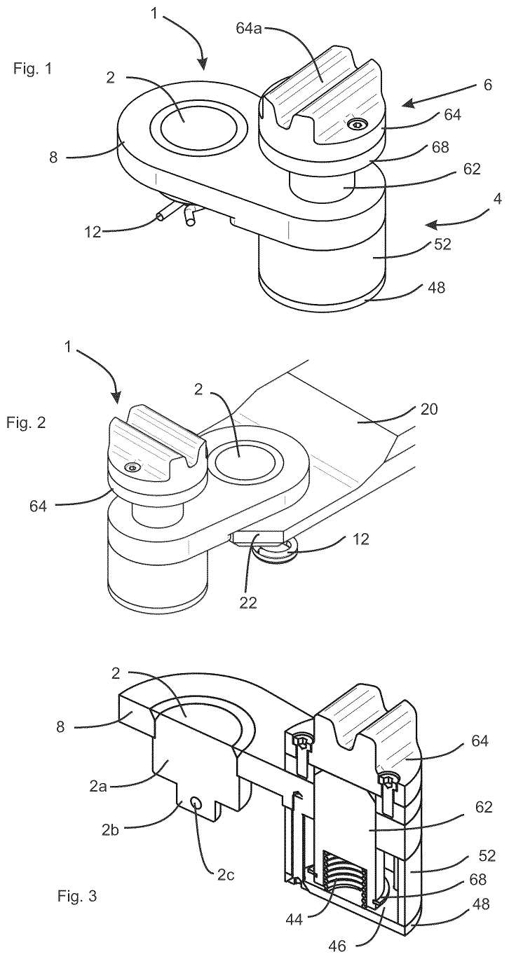

FIG. 1 shows a perspective view of a carrying apparatus 1 according to the invention, which has a first connecting means 2 with which the carrying apparatus 1 can be attached to a carrying arm (not shown). For this purpose, a projection (not shown) projects downwards. The reference sign 12 identifies a securing means with which the connecting means can be locked relative to the support arm (not shown).

The connecting means 2 is welded to an extension arm 8. Furthermore, a receiving device 4 is provided on this extension arm, which has and/or receives a carrying device, designated in its entirety as 6, for carrying the motor vehicle. This carrying device 6 has a contact body 64 or a contact element 64, which has a profile 64a, which engages accordingly in an area of the vehicle to be lifted. Preferably, this contact element 64 is detachably attached to a connecting collar 68 and is preferably made of plastic.

The reference sign 62 indicates a rod-like body, which also forms a component of the carrying device 6. The connecting collar 68 is preferably attached to the rod-like body 62 and in particular welded on.

The reference sign 48 characterises a bottom and/or a bottom part which delimits the receiving device 4 at the downwards and the reference sign 52 characterises a circumferential wall which surrounds a receiving space located therein.

FIG. 2 shows an illustration of the carrying apparatus 1 arranged on a support arm 20. The securing means 12, which is used to secure the carrying apparatus to the support arm 20, is also shown here. The support arm 20 has several straight edges so that the carrying apparatus can be attached to the support arm in different pivot positions. In the arranged or fastened state, however, the carrying apparatus 1 can no longer be pivoted relative to the support arm 20.

FIG. 3 shows a sectional view of the carrying apparatus shown in FIG. 1. It can be seen here that the connecting means 2 has a cylindrical section 2a and an equally but smaller cylindrical projection 2b. The reference sign 2c indicates a hole through which the securing means 12 can be guided.

It can also be seen that the receiving device 4 has a receiving space 46, within which the rod-like body 62 can be received and within which a spring 44 can also be received. This spring is preferably supported against the bottom 48.

FIG. 4 shows a sectional view of the apparatus shown in FIG. 2. Here, too, a receiving space or cavity 62a can be recognised, which is formed in the rod-like body 62 and receives the suspension device 44 in a lowered state. It can also be seen that the extension arm has a first section 8a and a second section 8b.

The section 8b, on which the receiving device 4 is arranged, has a recognisably larger thickness than the section 8a. In this way, a recess is formed which ensures that the carrying apparatus 1 cannot be pivoted relative to the support arm 20 in an assembled state.

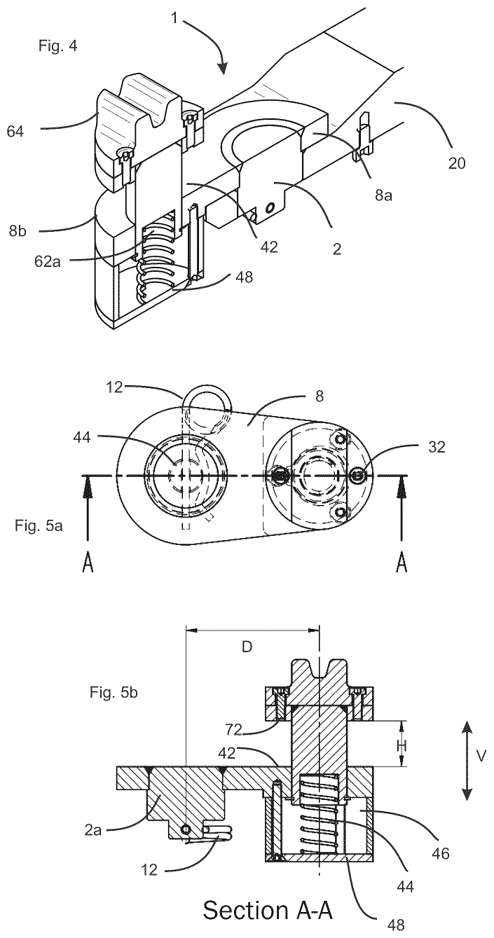

FIG. 5a shows a top view of the carrying apparatus according to the invention. Here again, the securing means 12 and also the suspension device 44 are provided. The reference sign 32 indicates one of two screw connections by which the contact element 64a can be fastened to the rod-like body 62.

FIG. 5b shows a view along line AA from FIG. 5a.

The reference sign D indicates the distance between the receiving device and the connecting means. The reference sign H indicates the way into which the contact body can be pressed. This can be approx. 30 mm, for example. When the contact element is pressed downwards in the relieved state shown here in FIG. 5b, the spring device 4 is compressed at the same time.

The reference sign 42 indicates a circular ring-shaped support section of the receiving device and/or the extension arm 8, which serves to support the carrying device 4 when it is pressed down onto the extension arm 8 in the direction V.

The reference sign 72 indicates a corresponding second support section, which also extends in a circular ring around the rod-like body 62. This second support section is advantageously formed on the collar 68.

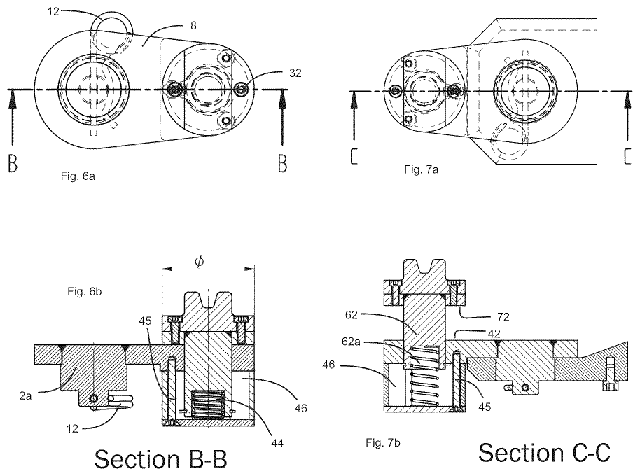

FIG. 6a shows a further top view of the apparatus according to the invention.

FIG. 6b shows a top view along line B-B of a section of the carrying apparatus. In FIG. 6b, the carrying apparatus is shown in a loaded state, in which the spring 44 is completely arranged in the recess 62a of the rod-like body 62. The reference sign 45 indicates a fastening means, such as a screw, with which the entire receiving device is screwed to the extended arm 8.

FIG. 7a shows a further illustration of the carrier apparatus arranged on the support arm 20.

FIG. 7b shows a view along section C-C from FIG. 7a. The arrangement of the extension arm 8 on the support arm 20 can be recognised here. In the illustration shown in FIG. 7b, the spring is relieved and the contact body is extended upwards accordingly. A user can press this down manually and thus optimally position the contact body 64 in relation to a vehicle.

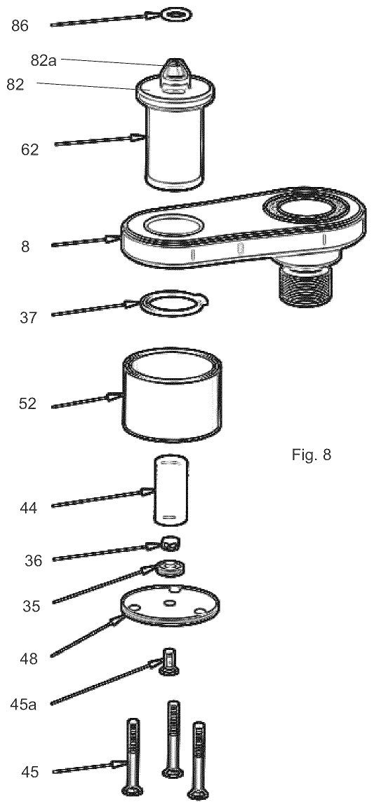

FIG. 8 shows an exploded view of a carrying apparatus according to the invention. In this apparatus, the extension arm 8 is again provided, on which the circumferential or cylindrical wall 52 or sleeve is arranged. In addition, the suspension means 44 is also provided, which is arranged inside the circumferential wall 52.

In addition, a positioning means 35 is provided for positioning the suspension means, wherein this positioning means preferably being fastened to the bottom part 48 by a screw 45a, in particular a countersunk screw and a screw nut 36.

The reference symbol 37 indicates a securing ring.

A first adapter element is arranged and in particular attached to the rod-like body. This can be a permanent fastening. The reference sign 86 indicates an O-ring, which can be arranged on the projection 82a of the first adapter element 82.

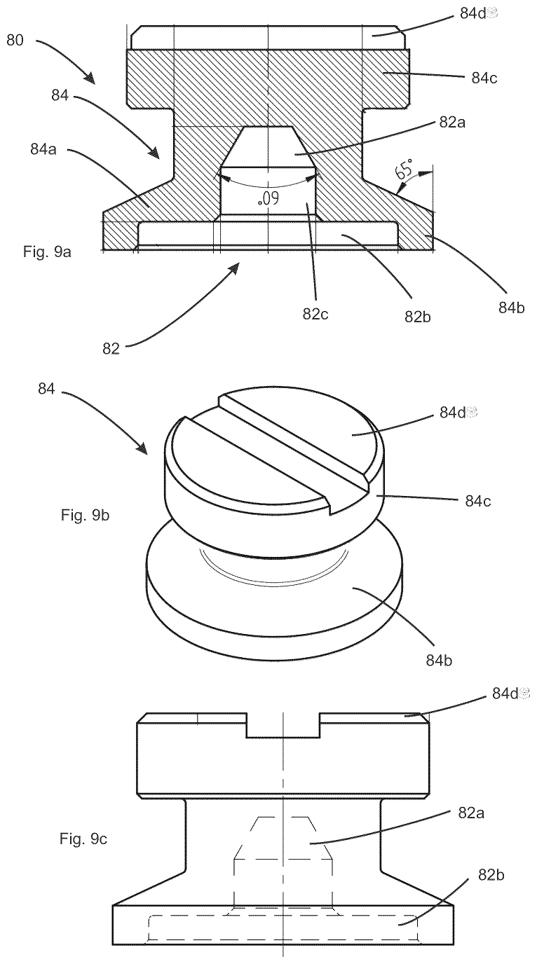

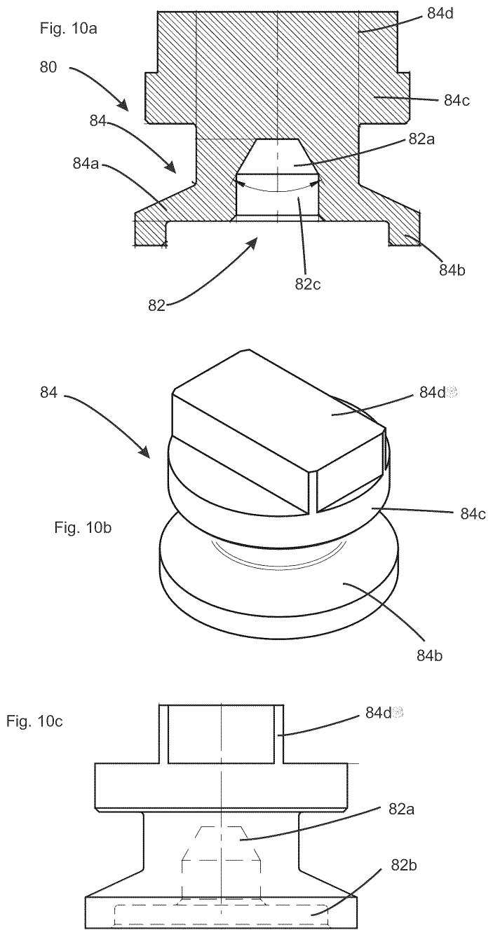

FIG. 9a shows a sectional view of the adapter device 80 in a first embodiment. This has the first adapter element 82 mentioned above, as well as the contact body 84, which can be pushed onto this adapter element 82.

The first adapter element preferably has a main plate 82b, on which a projection (82a, 82c) is arranged. This projection preferably has a cylindrical section 82c and a frustoconical section 82a.

The contact body 84 has a recess into which the projection 82a, 82c can enter. The geometric shape of this recess is adapted to the projection. The contact body 84 is therefore preferably arranged essentially free of play on the first adapter element 82. The contact body 84 thus preferably represents the second adapter element of the adapter device 80.

The reference sign 84b indicates a section of the contact body, in particular on the end face, which serves to accommodate a bottom section 82b of the first adapter element 82.

The reference sign 84c indicates a carrier section on which a contact section 84d is arranged, which is applied to an area of the vehicle (not shown).

The contact body is preferably made of a plastic and in particular of POM.

It can be seen that the recess of the contact body has a predetermined opening angle for receiving the protrusion. This opening angle is preferably between 20° and 90°, preferably between 30° and 80°, preferably between 40° and 80°, preferably between 50° and 70° and particularly preferably (as shown) at 60°.

FIG. 9b shows a perspective view of the contact body. This has a receiving profile 84d for attachment to a motor vehicle from a specific manufacturer.

FIG. 9c shows a further illustration of the adapter device, which consists of the contact body 84 and the first adapter element 82.

FIGS. 10a-c show a further adapter device which differs from that in FIGS. 9a-c in the shape or profile 84d of the contact body. This profile 84d is used to accommodate a different type of vehicle.

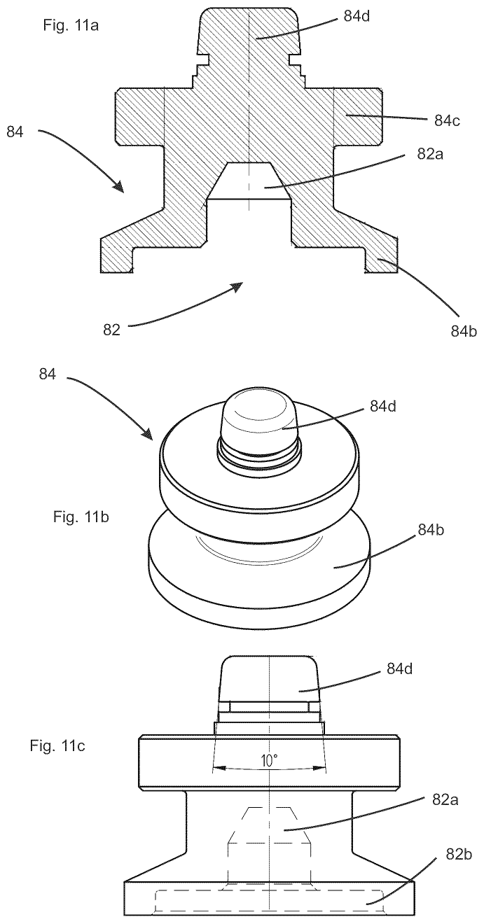

FIGS. 11a-c show a further adapter device which differs from that in FIGS. 9a-c in the shape or profile 84d of the contact body. This profile 84d is used to accommodate a different type of vehicle.

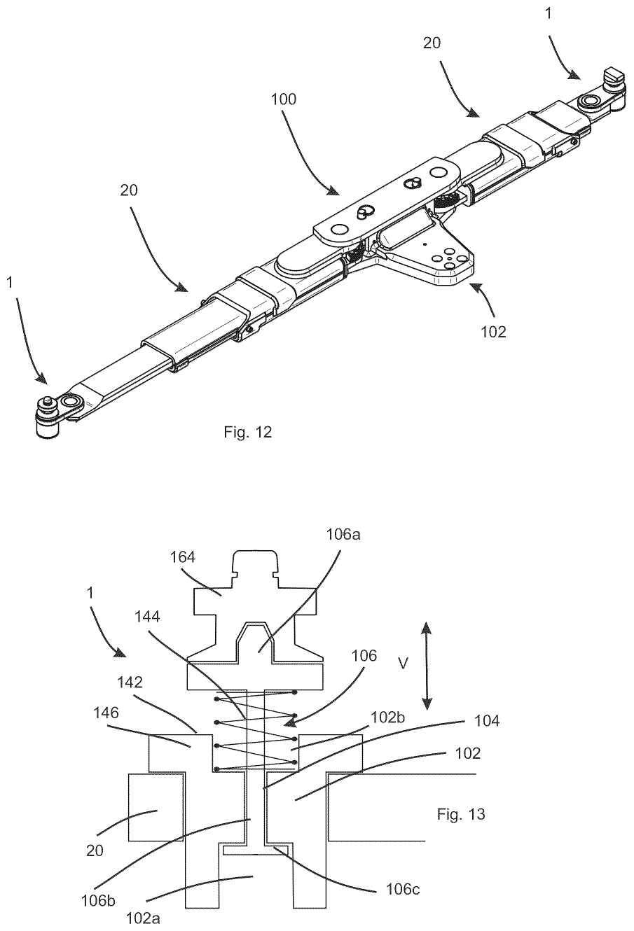

FIG. 12 shows an overall view of the use of the apparatus according to the invention. Two support arms 20 are pivotably arranged on a main carrier 100. This main carrier has a connecting device for connecting to a lifting platform or a component of a lifting platform.

An apparatus 1 according to the invention is arranged on each of the two support arms. It can be seen that an apparatus 1 equipped with a first contact body is arranged on the right-hand support arm and an apparatus 1 equipped with a second contact body is arranged on the left-hand support arm.

FIG. 13 shows a further embodiment of a carrying apparatus according to the invention. This differs from the embodiments shown above in that no extension arm is provided here, but a connecting means 102 is inserted directly on the support arm.

For this purpose, the connecting means has a central section that can be inserted into the support arm or a corresponding opening in the support arm 20.

The reference sign 146 indicates a support body that can be supported relative to the support arm. In particular, this support body is a circumferential collar that is supported relative to the support arm 20.

The reference sign 104 characterises a receiving device, which is designed here as a cylindrical bore. A carrying device 106, or more precisely a rod-like body 106b of this carrying device, is received or guided in this receiving device. The carrying device is movable in the direction V relative to the receiving device 104 and thus also movable relative to the connecting means 102.

The reference sign 144 characterises a suspension device which urges the carrying device 106 upwards in the vertical direction V. Furthermore, the carrying device 106, or more precisely a carrying body 106a, which is a component of this carrying device 106, can be supported relative to a support section 142, which in turn is a component of the connecting means. Preferably, the suspension device 144 is also supported relative to the connecting means 102. In addition, the connecting means 102 preferably has a recess 102b into which the suspension device can be pushed.

The reference sign 164 again identifies the contact body, which is changeable with respect to the carrying body 106a in order to enable adaptation to different vehicles.

The reference sign 106c indicates a stop, which is also a component of the carrying device 106 and limits the movement of the carrying device 106 relative to the connecting means 102 in the vertical direction.

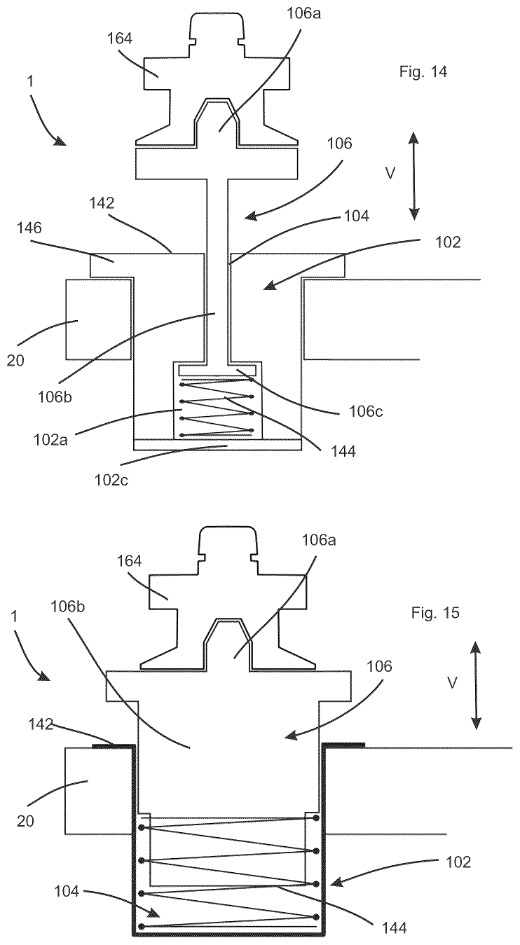

FIG. 14 shows a further embodiment of a carrying device according to the invention. Here too, the connecting means 102 is inserted into the support arm and the receiving device is again movable in the direction V relative to the connecting means. Here, the connecting means again forms a receiving space 102a, in which, however, the suspension device 144 is also arranged.

The reference sign 102c indicates a bottom part which supports the receiving space downwards and absorbs the force of the suspension device 144 in a compressed state. Thus, in the embodiment shown in FIG. 14, the suspension device 144 is formed completely below the support arm 20 or its plane, whereas in the embodiment shown in FIG. 13, the suspension device is formed completely above the support arm or its plane.

FIG. 15 shows a further embodiment of a carrying apparatus according to the invention. Here, the connecting means 102 is designed as a relatively thin sleeve, preferably closed downwards, which this sleeve is inserted into the support arm. The receiving device here is the interior space formed by the connecting means or this sleeve, within which interior space the carrying device 106 or its relatively large main body 106b is received.

In this embodiment, the receiving device or the connecting means also directly accommodates the suspension device 144. Furthermore, however, the connecting means 102 also forms a support section 142 for supporting the carrying device 106, wherein this support section 142 is also relatively thin here and is again supported on the support arm.

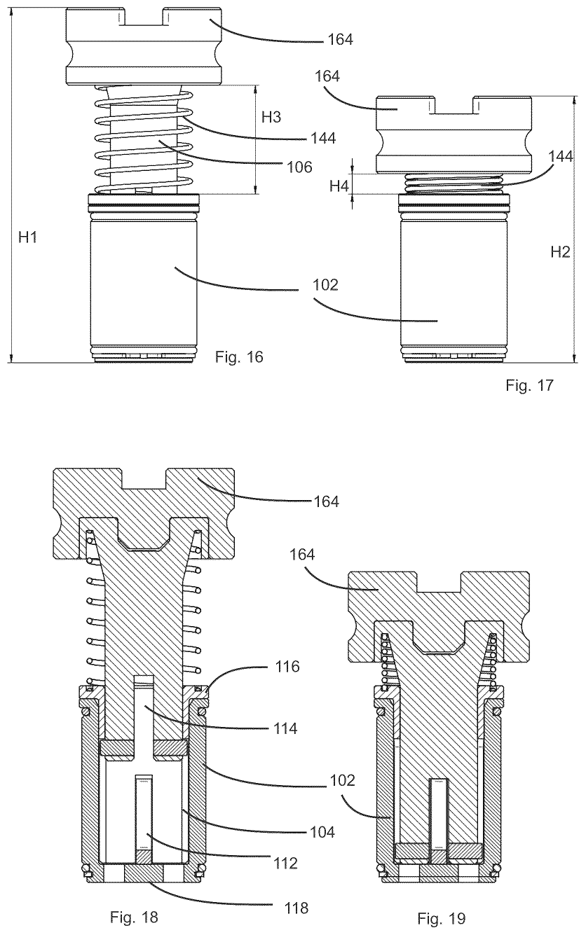

FIG. 16 shows a further embodiment of a carrying apparatus according to the invention in a relaxed state. This means that the suspension device 144 is in a relaxed state and thus the contact body is in a completely pushed-up state.

FIG. 17 shows the carrying apparatus from FIG. 16 in a tensioned, i.e. here compressed, state of the suspension device.

The reference sign H1 indicates the height of the carrying apparatus in this state. This height H1 is preferably between 100 mm and 200 mm, preferably between 120 mm and 190 mm, preferably between 140 mm and 180 mm and preferably between 150 mm and 170 mm.

The reference sign H3 indicates the height between the connecting means 102 and the contact body or its underside in the relaxed state. This height H3 is preferably between 20 mm and 80 mm, preferably between 30 mm and 70 mm, preferably between 40 mm and 60mm and particularly preferably between 45 mm and 55 mm.

The reference sign H2 indicates the height of the carrying apparatus in the fully tensioned, i.e. here compressed, state and thus the minimum height of the carrying apparatus. This height H3 is preferably between 80 mm and 160 mm, preferably between 100 mm and 140 mm, preferably between 110 mm and 130 mm and preferably between 115 mm and 125 mm.

The reference sign H3 indicates the height between the connecting means 102 and the contact body or its underside in the tensioned state. This height H3 is preferably between 5 mm and 20 mm, preferably between 6 mm and 15 mm, preferably between 7 mm and 12 mm and particularly preferably between 8 mm and 10 mm.

Preferably, the spring path that the contact body can move in relation to the connecting means is between 20 mm and 60 mm, preferably between 30 mm and 50 mm and preferably between 35 mm and 45 mm.

FIGS. 18 and 19 show a sectional view of the carrying apparatus shown in FIG. 16. A guide body 116 can also be recognised here, in relation to which the suspension device 144 is supported and which in turn is supported in relation to the connecting means 102. The connecting means in turn is supported against the support arm (not shown) of a lifting platform.

Furthermore, a guide groove provided in the carrying device 106 can be recognised, in which a projection 112 engages in a retracted state of the carrying apparatus (see FIG. 19). This projection is arranged on a carrier 118.

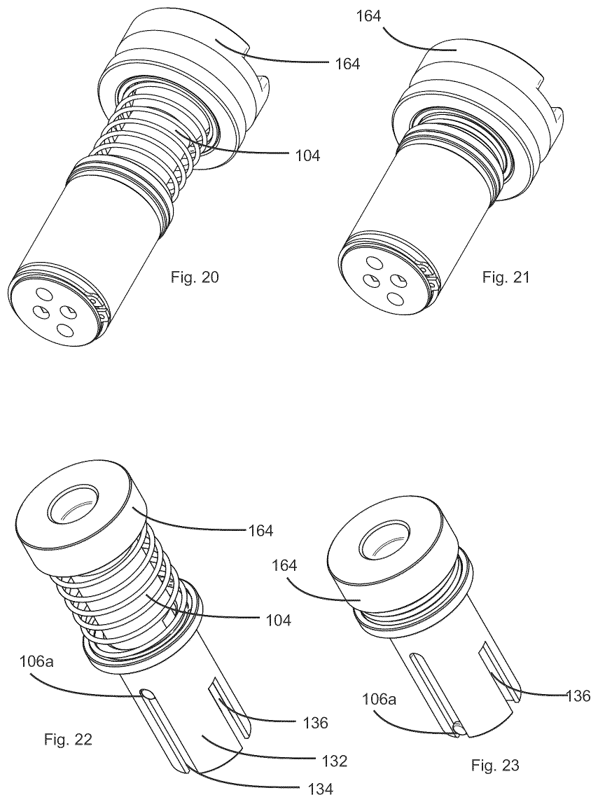

FIGS. 20 and 21 each show perspective views of the carrying apparatus.

FIGS. 22 and 23 show a further carrying apparatus according to the invention with an amended contact body and without the connecting means. Guide grooves 134 for guiding a pin 106a, which is arranged on the carrying device 106, can be recognised here. This pin is in an upper position in the situation shown in FIG. 22 and in a lower position in the situation shown in FIG. 23.

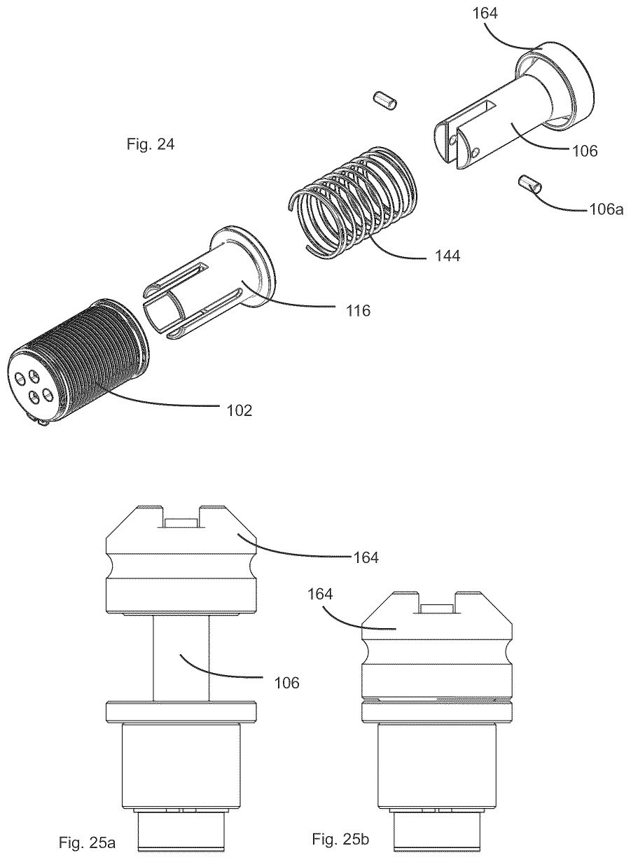

FIG. 24 shows an exploded view of the carrying apparatus shown in FIG. 22. The pins 106a, which are inserted into the carrying device 106, are also shown again. In addition, the guide body 116, which can be inserted into the connecting means 102, is also recognisable. This guide body preferably has four guide grooves, wherein two guide grooves preferably having a greater length than the other two guide grooves. Preferably, the longer guide grooves are used to guide the pins 106a. Preferably, the shorter guide grooves are used to guide the guide body relative to the connecting means 102 and, in particular, to guide it in a torsion-resistant manner.

FIGS. 25a, b show a further illustration of a carrying apparatus according to the invention, wherein FIG. 25a showing an extended state and FIG. 25b a retracted state.

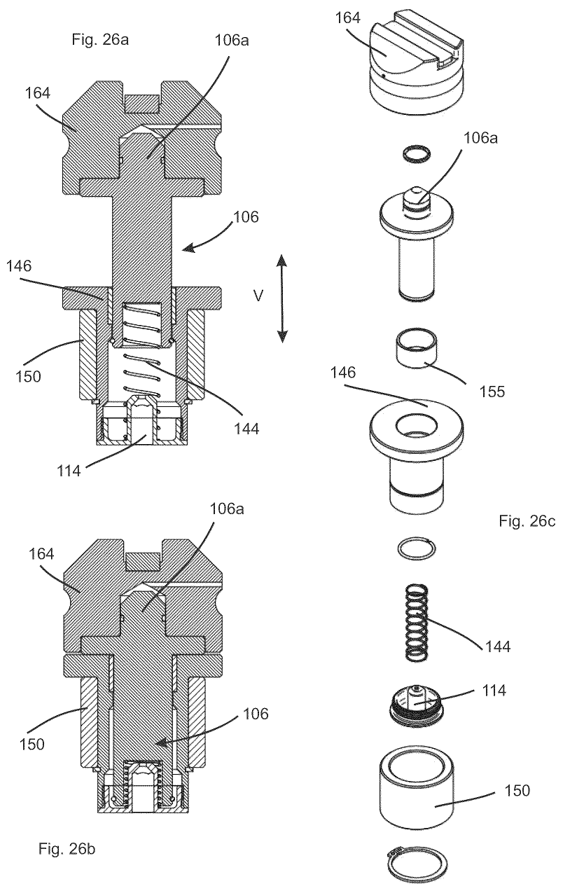

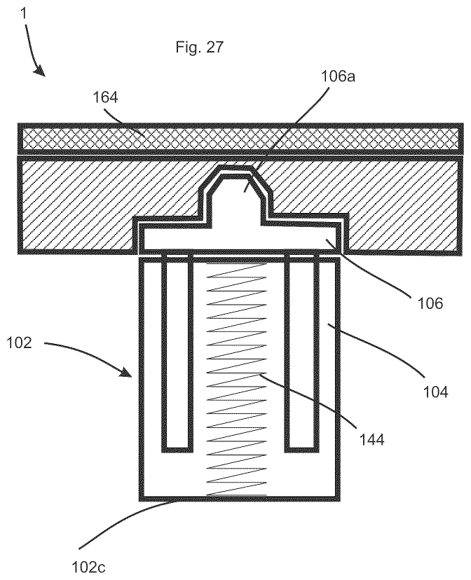

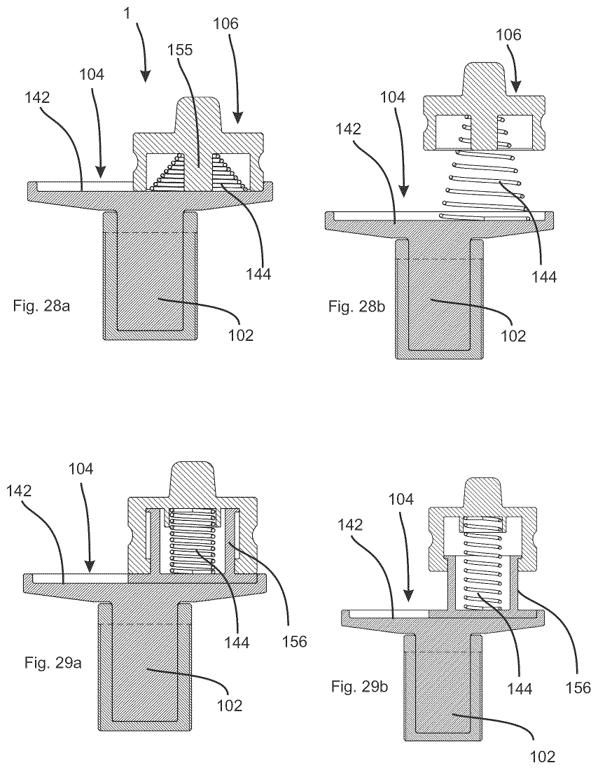

FIGS. 26a, b each show a sectional view of the carrying apparatus shown in FIGS. 25a, b. A special feature of this carrying apparatus is the sleeve body 150, which allows the carrying apparatus to be inserted into differently dimensioned support arms (e.g. from different manufacturers). FIG. 26c shows an exploded view of the carrying apparatus shown in FIG. 25a, b.

In addition, a further guide sleeve 155 is advantageously provided, which guides the movement of the carrying device 106 relative to the support body 146.

FIG. 27 shows a further embodiment of the present invention. In this embodiment, the support surface for the vehicle is considerably larger than in the previous embodiments. In addition, however, the suspension device already described above is again provided here. In addition, longitudinal guiding devices (not shown) may also be provided, which additionally guide the movement of the carrying device 106 relative to the connecting means. Due to the larger contact surface, eccentric force application can occur more easily with this design, so that these longitudinal guiding devices are preferably also suitable and intended to absorb forces occurring in the horizontal direction.

FIGS. 28a and 28b show a further embodiment of a carrying apparatus according to the invention. Here too, the receiving device 104 has a support section 142 for receiving the connecting means. The connecting means 106 accommodates the suspension means 144 in its interior. The suspension means is guided by a guide rod 155. Furthermore, the suspension means preferably has a diameter that widens from top to bottom, although this is optional. The suspension means can be attached on its upper side on the connecting means.

The embodiment in FIGS. 29a and 29b is similar to that in FIGS. 28a and 28b. In addition, a limiting means 156 is provided here, which limits the return of the suspension means. The suspension means 144 is accommodated here in an interior of the connecting means.

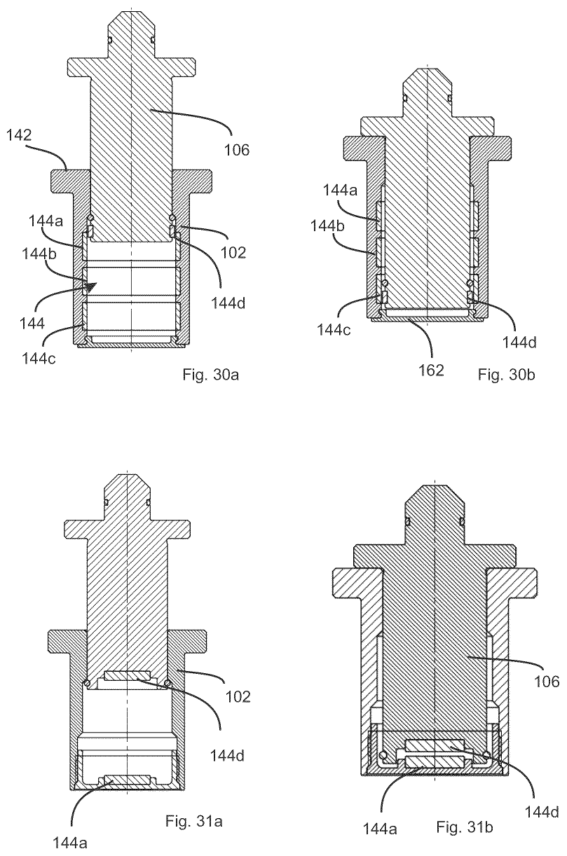

FIGS. 30a and 30b show a further embodiment of a carrying apparatus according to the invention. Here, the suspension means 144 is designed as a magnetic suspension means. More precisely, three first ring-shaped magnetic means 144a, 144b and 144c are provided here, which are arranged on the connecting means. A further magnetic means 144d is arranged on the receiving device. In this way, the further magnetic means 144d can be moved relative to the three first magnetic means 144a, b, c.

In the embodiment shown in FIGS. 31a and 31b, a first magnetic means is arranged on the connecting means 102 and a second magnetic means 144c is arranged on the receiving device 106. The further the receiving device is moved downwards, the more strongly the magnetic means 144a and 144d will repel each other so that the “spring force” also increases here.

Neodymium magnets, for example, could be used as magnetic means.

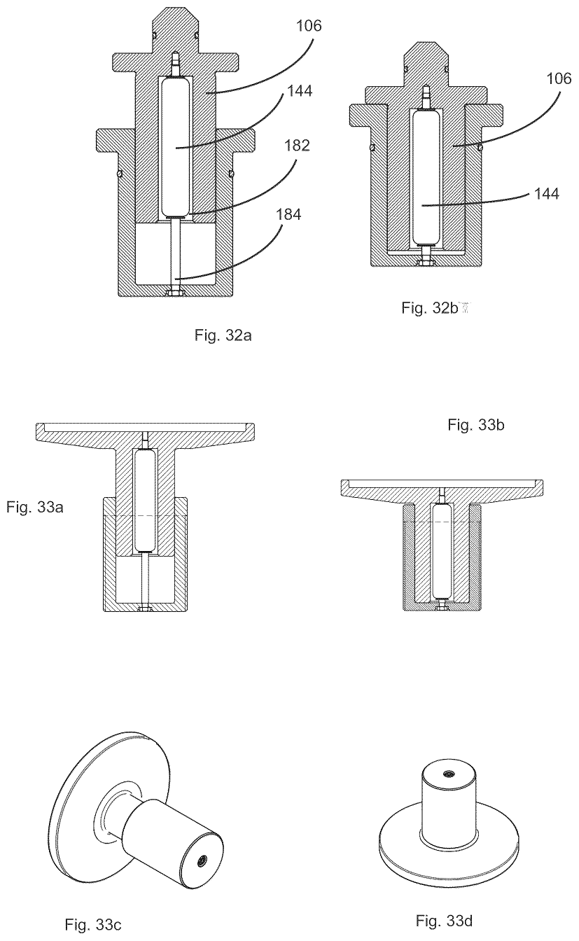

FIGS. 32a and 32b show a further embodiment of the carrying apparatus according to the invention. Here, the suspension means is designed as a pneumatic spring and is preferably fully integrated in the receiving device 106. For this purpose, the receiving device 106 has a recess which serves to receive the suspension means 144. However, the suspension means could also be a coil spring or a magnetic spring.

The reference symbol 184 shows a piston element which enters further into the pneumatic suspension means when the receiving device is pressed down, thus increasing the spring force.

FIGS. 33a-33d show a similar design, wherein here a receiving surface is formed on the upper side, which can be used to receive an adapter element (not shown).

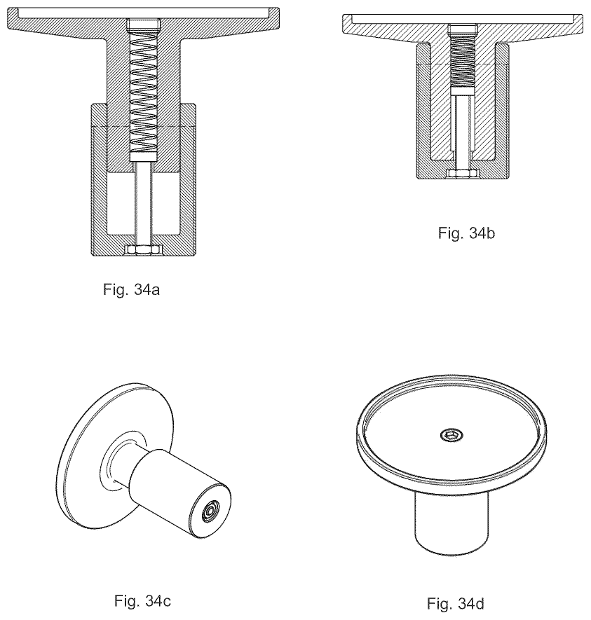

FIGS. 34a-34d show a further embodiment of the invention, wherein a suspension means in the form of a coil spring is inserted in the receiving device or its recess.

The applicant reserves the right to claim all features disclosed in the application documents as being essential to the invention, provided that they are new compared to the prior art, either individually or in combination. It should also be noted that the individual figures also describe features which may be advantageous in themselves. The skilled person immediately recognises that a particular feature described in a figure can also be advantageous without the adoption of further features from this figure. Furthermore, the skilled person recognises that advantages can also result from a combination of several features shown in individual figures or in different figures.

1. A carrying apparatus for lifting and/or carrying motor vehicles, having a first connecting device configured to be connected to a support arm of a lifting platform and/or received by the support arm, and having a receiving device formed by the connecting device and having a carrying device received by the receiving device for carrying the motor vehicle, wherein the connecting device forms a support section for supporting the carrying device, wherein
the carrying device is movable along a straight direction relative to the receiving device and a suspension device is provided which urges the carrying device into a first position of the carrying device relative to the receiving direction.

2. A carrying apparatus for lifting and/or carrying motor vehicles, having a first connecting device configured to be connected to a support arm of a lifting platform and having a receiving device arranged rigidly on the connecting device and having a carrying device received by the receiving device for carrying the motor vehicle, wherein the receiving device forms a support section for supporting the carrying device, wherein
the carrying device is movable along a straight direction relative to the receiving device and a suspension device is provided which urges the carrying device into a first position of the carrying device relative to the receiving direction.

3. The carrying apparatus according to claim 1, wherein
the carrying device is movable relative to the support section in a direction perpendicular to the straight direction and/or the carrying device is rotatable relative to the support section with respect to a vertical direction.

4. The carrying apparatus according to claim 1, wherein
the support section forms a support surface within which the carrying device is movable relative to the support section and/or the support section forms a circumferential edge which limits the movement of the carrying device relative to a support surface within which the carrying device is movable relative to the support section.

5. The carrying apparatus according to claim 1, wherein
the receiving device is a recess arranged in the connecting device, which recess preferably extends in the straight direction.

6. The carrying apparatus according to claim 1, wherein
the carrying device is movable along the straight direction relative to the connecting device between two end positions and preferably a maximum movement path of the carrying device relative to the receiving device is greater than 10 mm and/or a maximum movement path of the carrying device relative to the receiving device is less than 200 mm.

7. The carrying apparatus according to claim 1, wherein
the carrying apparatus has an adapter device which makes it possible to arrange different contact bodies on the carrying device.

8. The carrying apparatus according to claim 5, wherein the carrying device comprises a rod-like body is made of a metal and/or in that the contact body is made of a plastic.

9. The carrying apparatus according to claim 5, wherein a device is formed on the contact body for engaging in regions of a vehicle.

10. The carrying apparatus according to claim 1, wherein the suspension device is selected from the group consisting of a coil spring, a pneumatic spring and a magnetic spring.

11. The carrying apparatus according to claim 1, wherein
a recess extending in the straight direction is arranged in the receiving device and a spring device is arranged within this recess.

12. The carrying apparatus according to claim 11, wherein
the recess in the straight direction has a length which is greater than 2 cm.

13. The carrying apparatus according to claim 11, wherein
the recess in a direction perpendicular to the straight direction has a diameter which is greater than 1 cm.

14. The carrying apparatus according to claim 1, wherein
the carrying apparatus has at least one sensor device which is configured for determining a force exerted on the carrying apparatus.

15. A lifting platform for lifting motor vehicles, having several support arms which are configured for lifting the vehicle, wherein a carrying device as claimed in claim 1 is arranged on at least one support arm.

16. The carrying apparatus according to claim 6, wherein the carrying device comprises a rod-like body is made of a metal and/or in that the contact body is made of a plastic.

17. The carrying apparatus according to claim 6, wherein a device is formed on the contact body for engaging in regions of a vehicle.

18. The carrying apparatus according to claim 2, wherein the suspension device is selected from the group consisting of a coil spring, a pneumatic spring and a magnetic spring.

19. The carrying apparatus according to claim 7, wherein a device is formed on the contact body for engaging in regions of a vehicle.

20. The carrying apparatus according to claim 3, wherein the suspension device is selected from the group consisting of a coil spring, a pneumatic spring and a magnetic spring.
